(19) United States
(12) Patent Application Publication
(10) Pub. No.: US 2026/0300861 A1
(43) Pub. Date: Oct. 1, 2026

(54) INVENTORY FLOW POSITIONING SYSTEM

(71) Applicant: Target Brands, Inc., Minneapolis, MN (US)

(72) Inventors: Thomas James Miller, Minneapolis, MN (US); William Vincent Fazio, Maple Grove, MN (US); Sayam Nasim, Blaine, MN (US)

(21) Appl. No.: 19/094,181

(22) Filed: Mar. 28, 2025

(51) Int. Cl. G06Q 10/0631; B65G 1/137; G06Q 10/083; G06Q 10/087

(52) U.S. Cl. CPC G06Q 10/06315; B65G 1/1376; G06Q 10/083; G06Q 10/087; B65G 2203/04

(57) ABSTRACT

In some implementations, systems and methods for positioning inventory can include receiving an inbound shipment at a warehouse. A determination is made to decide if one or more inventory updates for the inbound shipment is made within a threshold amount of time. One or more inventory need amounts are determined for retail locations associated with the warehouse. Based on the one or more inventory need amounts, a determination is made that one or more items in the inbound shipment are to be shipped or that the one or more items are to be warehoused. An allocation of the one or more items is automatically transported from an inbound area to an outbound area for an outbound shipment.

### TECHNICAL FIELD

This specification generally relates to technology for relocating inventory through a warehouse for shipment for retail inventory replenishment.

### BACKGROUND

Supply chains are, in general, complex networks through which goods are supplied from producers to retailers and, ultimately, consumers. Goods in a supply chain may be stored in warehouses for extended periods of time before being delivered to retailers and/or consumers. As a result, warehouses use resources to warehouse goods on shelving for extended periods of time before the goods are moved from the warehouse facility to a retailer. The storing of goods on shelving over long periods of time and retrieving goods from shelving to supply retailers can be time consuming, deplete warehouse resources, and can cause delays leading to retailers being out of stock.

### SUMMARY

This document generally describes systems and processes for positioning inventory in a supply chain by flow positioning which can flow inventory through a warehouse automatically to an outbound shipment for retail inventory replenishment in a timely fashion instead of warehousing the inventory.

In some implementations, a method for the disclosed technology can include receiving an inbound shipment at a warehouse. The method further includes determining, by an inventory replenishment system, if one or more inventory updates for the inbound shipment are made within a threshold amount of time. The method further includes determining one or more inventory need amounts for one or more retail locations associated with the warehouse. The method further includes, based on the one or more inventory need amounts, determining, by the inventory replenishment system, that one or more items in the inbound shipment are to be shipped or that the one or more items are to be warehoused. The method further includes automatically transporting an allocation of the one or more items from an inbound area to an outbound area for an outbound shipment.

In some implementations, a system can be used for the positioning of inventory. The system includes one or more processors. The system includes computer-readable memory. The computer-readable memory stores instructions that, when executed by the processors, cause the processors to perform operations including receiving an inbound shipment at a warehouse. The operations further include determining, by an inventory replenishment system, if one or more inventory updates for the inbound shipment are made within a threshold amount of time. The operations further include determining one or more inventory need amounts for one or more retail locations associated with the warehouse. The operations further include based on the one or more inventory need amounts, determining, by the inventory replenishment system, that one or more items in the inbound shipment are to be shipped or that the one or more items are to be warehoused. The operations further include automatically transporting an allocation of the one or more items from an inbound area to an outbound area for an outbound shipment.

Other implementations of this aspect include corresponding computer systems and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. Determining if the one or more inventory updates have been made within a threshold amount of time comprise determining that the one or more inventory updates were not made within a first window of time and the determining if the one or more inventory updates have been made within the threshold amount of time comprises determining that the one or more inventory updates have been made within a second window of time, wherein the first window of time and the second window of time are within the threshold amount of time. The operations further comprise, waiting to process one or more flow signals associated with the shipment based on the determining that that the one or more inventory updates were not made within the first window of time and processing the one or more flow signals associated with the shipment based on determining that the one or more inventory updates have been made within the second window of time. Automatically transporting the allocation of the one or more items comprises transporting the one or more items using one or more conveyor systems. Determining, by the inventory replenishment system, that one or more items in the inbound shipment are to be shipped or that the one or more items are to be warehoused comprises determining that a flow transfer order request has been created for the one or more items. The operations further comprise, determining the allocation of one or more items based on the one or more inventory need amounts, wherein the one or more inventory need amounts are determined for a time period. Determining, by the inventory replenishment system, that one or more items in an inbound shipment are to be shipped or that the one or more items are to be warehoused comprises determining that the one or more items are associated with a shipment category. Receiving the inbound shipment at the warehouse comprises receiving a flow signal associated with the inbound shipment, determining, by the inventory replenishment system, that the one or more items in the inbound shipment are to be shipped or that the one or more items are to be warehoused comprises generating a flow transfer order request for the one or more items, and based on a flow transfer order request, shipping the one or more items in the outbound shipment to the one or more retail locations. Automatically transporting the allocation of the one or more items from an inbound area to an outbound area for an outbound shipment comprises transporting the allocation of the one or more items within the same day without warehousing the allocation of the one or more items. Automatically transporting the allocation of the one or more items from an inbound area to an outbound area for the outbound shipment comprises identifying the one or more items by scanning the one or more items while the one or more items are guided through a conveyor system.

The systems, devices, program products, and processes described throughout this document can, in some instances, provide one or more of the following advantages. For example, determining the current status and state of a supply chain can be complex when processing large scale supply chain data that can change rapidly. The disclosed technology provides improved solutions to supply chain systems in that it can relocate inventory with computational efficiencies. In another example, the disclosed technology can reduce the time to replenish store inventories to appropriate levels while avoiding storage and retrieval resource costs at warehouses. In another example, the disclosed technology can position inventory so as to reduce over allocation of products to retail stores. In another example, the disclosed technology can improve the volume of items shipped from a warehouse during a period of time which can improve warehouse operational efficiencies and can reduce labor requirements in a warehouse. For example, the disclosed technology can reduce the number of worker interactions with inventory and can allow for the processing of more volume of inventory in an amount of time. In another example, the disclosed technology can allow for inventory to be allocated downstream from a warehouse instead of being warehoused. In another example, the disclosed technology can allow for inventory to be allocated from a warehouse efficiently to comply with regulatory requirements. In another example, the disclosed technology can leverage time windows so inventory can be efficiently allocated from a warehouse to stores when there are race conditions between systems. In another example, the disclosed technology can allow for allocation of inventory by analysts from a warehouse.

Other features, aspects and potential advantages will be apparent from the accompanying description and figures.

### DESCRIPTION OF DRAWINGS

FIG. 1 depicts an example warehouse environment and an exemplary system for positioning inventory in a supply chain using flow positioning.

FIG. 2 is a diagram that shows an example supply chain for flow positioning inventory.

FIG. 3 is a flowchart of an exemplary process for positioning inventory from a warehouse to retailers using flow positioning.

FIG. 4 is a diagram that shows an exemplary process for positioning inventory in a supply chain using flow positioning.

FIG. 5 is a diagram that shows an exemplary timeline for the positioning of inventory using flow positioning.

FIG. 6 is a diagram that shows exemplary systems used in the positioning of inventory using flow positioning.

FIG. 7 is a diagram showing and exemplary architecture used in the positioning of inventory using flow positioning.

FIG. 8 is a schematic diagram that shows an example of a computing system.

Like reference symbols in the various drawings indicate like elements.

### DETAILED DESCRIPTION

This document describes technology that can position inventory by flow positioning which can flow inventory through a warehouse automatically to an outbound shipment for a retailer instead of warehousing the inventory. In a supply chain environment, for example, where the state of inventory can change rapidly over time between many facilities and retailers, determining where inventory can be relocated for shipment before being warehoused can be beneficial in reducing the time to replenish store inventories to appropriate amounts. In some implementations, flow positioning includes unloading a shipment of inventory received at a warehouse and deciding which inventory items are to be relocated to outbound shipments to retailers automatically using conveyor systems and which inventory items are to be warehoused for later shipment. In some implementations, the inventory can be flow positioned soon after it is arrived at a warehouse based on an inventory replenishment system identifying needs at retailers or the inventory is warehoused if a retail need is not identified within a threshold amount of time. For example, products arriving in a shipment at a warehouse can be shipped to a store that has an identified need for the products in the same day or shift and other products on the shipment can be warehoused for shipment to retailers the next day or at a later identified time. In some implementations, evaluating shipments of inventory in widows of time after receipt at a warehouse can allow for inventory information to be updated in an inventory replenishment system before allocation decisions are made for the received inventory. For example, flow positioning can relocate products quickly and create efficiencies by avoiding storage and retrieval warehousing resource costs. Also, for example, flow positioning inventory can decrease the number of times workers interact with and/or touch items in a warehouse and can decrease the time a product is located at a warehouse. In some implementations, flowing inventory through a warehouse before the inventory is stored in warehouse storage and shipping to a retailer based on the retailer's inventory levels and recent updates for warehouse shipments can avoid over allocation of products to the retailer.

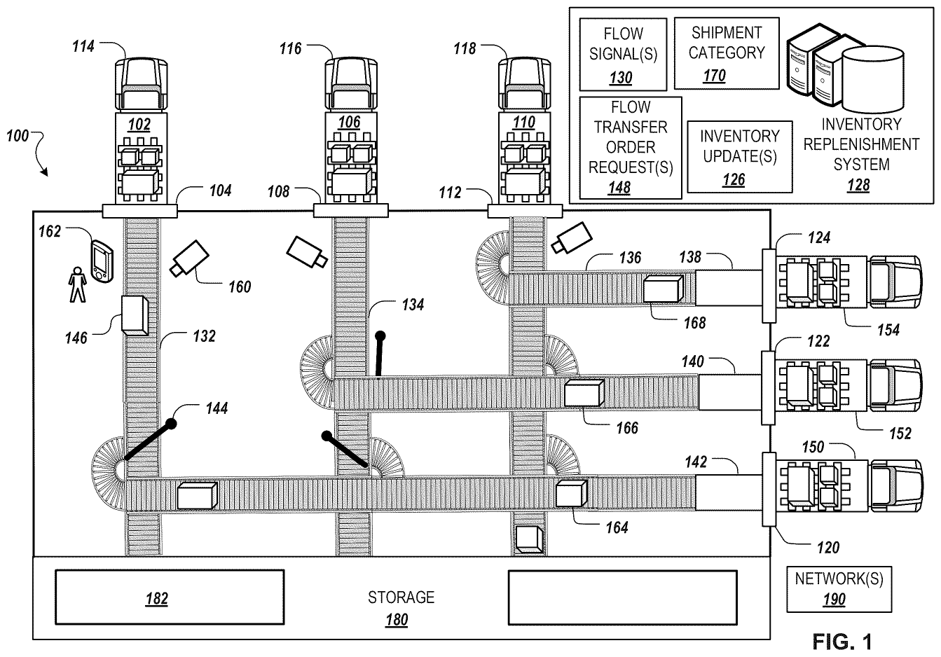

Referring to the figures, FIG. 1 shows a diagram of an example warehouse environment and an exemplary system for flow positioning inventory in a supply chain. In the example of FIG. 1, the warehouse 100 can include one or more inbound areas for inventory items such as inbound docks 104, 108, and 112. The inbound docks can be used for receiving shipments of inventory such as products or items where they can be temporarily held before being warehoused in long term storage or shipped using flow positioning. For example, inventory that arrives on a truck 114 can be held temporarily at the inbound area of inbound dock 104 before the inventory is repositioned or moved through the warehouse 100. Also, the warehouse 100, for example, can include one or more outbound areas such as outbound docks 120, 122, and 124. Outbound docks can be used to prepare and send shipments of inventory to one or more retailers. For example, inventory can be moved through the warehouse to outbound dock 120 to be shipped on shipment 150 to a designated retailer.

As shown in FIG. 1, one or more shipments such as inbound shipments 102, 106, and 110 can arrive and be received at a warehouse. In some implementations the shipments can arrive closely in time. When inventory arrives at a warehouse, for example, the available inventory for distribution by the warehouse to retailers can change but may not be reflected in a stored state of the supply chain until an update is made to the supply chain state. For example, one or more trucks such as trucks 114, 116, and 118 can arrive closely in time with shipments that change the available inventory of the warehouse to supply retailers. When a shipment arrives at the warehouse 100 workers can evaluate the shipment to determine what is included in the shipment. For example, an inventory or accounting of what is in the shipment can be determined or validated. In one exemplary implementation one or more inventory updates 126 for the inbound shipment 102 can be made to an inventory replenishment system 128. The exemplary inventory replenishment system 128 can determine and store the state or a portion of the state of the inventory in a supply chain. In some implementations updating the state of inventory can be useful in efficiently positioning inventory at retailers. Having an accurate accounting of the current state of inventory at one or more supply chain facilities can better assist in decision making for determining inventory allocations to be supplied to retailers. In an exemplary implementation, after a shipment is received at a warehouse, one or more flow signals 130 can be received by the inventory replenishment system 128 indicating that the shipment has been received at warehouse 100. The one or more flow signals 130, for example, can be associated with a time indicating when the shipment was received at the warehouse. In some implementations, the inventory replenishment system 128 can send and/or receive communications using one or more communications networks 190. In some implementations, the inventory replenishment system 128 can include one or more computing systems.

The exemplary warehouse 100, for example, can include one or more conveyor systems such as conveyors 132, 134, and 136 and one or more chutes such as chutes 138, 140, and 142. In some examples, conveyors and chutes can be arranged in various combinations to allow for items to be directed to an appropriate location within the warehouse facility. In one implementation, conveyors can be overhead conveyors that can transport items in an elevated system that can ultimately relocate items in one or more docks or bays. Conveyor systems, for example, can include rollers, multi-directional rollers, belts or the like to move items. Conveyor systems can include one or more sorting mechanisms to direct items through the conveyor system such as exemplary sorting mechanism 144. For example, conveyor systems can include automated arms, separators, diverters, pushers, machines, or the like in guiding an item through the conveyor system to a location within the warehouse. In some implementations, a conveyor system can move or position an inventory item through the warehouse from an inbound area to an outbound area automatically. A conveyor system, for example, can be configured so that one or more inbound areas or docks can be connected to one or more outbound areas or docks based on traversing the interconnected conveyor system. For example, an inventory item 146 that has been designated to be shipped using flow positioning, can be transported from inbound dock 104 to outbound dock 120 automatically using the conveyor system that includes conveyor 132 and chute 142. In some implementations, items in any inbound area or designated inbound area can be relocated or moved automatically to any outbound area or designated outbound area using the conveyor system. In some implementations, it can be beneficial to use flow positioning to move inventory from an inbound shipment to an outbound shipment before the inventory is warehoused on warehouse shelving or storage such as warehouse storage 180. Placing and retrieving inventory on shelving 182 or warehouse storage 180, for example, can deplete resources such as time, equipment, energy, workers and other like warehousing resources. In some implementations, storing inventory on warehouse shelving can include removing inventory from a conveyor system placing it in another area where it can be accessed by a forklift for storage on shelving or racks. Avoiding storing inventory on warehouse storage or shelving, for example, can achieve efficiencies in reduced time and resources in moving inventory through a warehouse to retailer shipments.

In exemplary implementations, after a shipment has been evaluated and it is determined what arrived in the shipment, the different items and products can be automatically directed to outbound shipments using flow positioning. In some implementations, the inventory replenishment system 128 determines which of the different items that arrived on the shipment can be processed with flow positioning and which of the different items can be stored in warehouse storage. For example, if a product or item is to be processed through flow positioning, the inventory replenishment system 128 can generate one or more flow transfer order requests 148 indicating that the designated product or item can be automatically relocated to an outbound area for an outbound shipment to a designated retailer and not to be stored in longer term warehouse storage 180. In some implementations, a determination can be made that the shipment 104 was evaluated within a threshold amount of time in determining if the shipment can be processed using flow positioning. For example, the inventory replenishment system 128 can determine if the shipment 102 was evaluated and an inventory update of what is in shipment 102 was made within a threshold amount of time such as one hour or other threshold amount of time. If shipment 102 was evaluated within the threshold amount of time the shipment can be processed using flow positioning. If shipment 102 was not evaluated within the threshold amount of time, then the shipment can be moved to warehouse storage 180 and shelving 182 and not processed using flow positioning. In some implementations of flow positioning, the items of a shipment can be put on the conveyor system to be automatically transported through the warehouse 100 to be included in one or more outbound shipments to one or more retailers. In some implementations, using flow positioning inventory items can be moved in grouped packaging when the items arrive in grouped packaging. Moving items that are packaged together, for example, can save resources that would be used in breaking down the packaging into smaller or individual items. In one implementation, an identifier or label on an item moving along the conveyor system can be scanned so that the item can be automatically identified and automatically guided through the conveyor system to an outbound area. For example, inventory item 146 can be scanned by a scanning device such as scanning device 160, handheld device 162 or other like scanning device to determine where the item is to be located by the conveyor system of warehouse 100. A scanning device 160, for example, can provide information to a computing system used to control the conveyor system when automatically moving inventory through the warehouse 100. In some implementations, inventory can be moved through the inventory based on item case packaging. In one exemplary implementation an inventory item such as inventory item 146 can be associated with one or more shipment categories (e.g., flammable item, hard allocation, fixed assortment, etc.) such as shipment category 170 where the inventory item 146 can be designated for shipment to a retailer using flow positioning so that the item 146 is shipped from the warehouse before a deadline (e.g., end of day, end of shift, designated time, etc.).

In one example, in determining where inventory is shipped, the inventory replenishment system can determine which retailers have a need for the inventory. For example, designated items 164, 166, and 168 from shipment 110 can be distributed to outbound shipments 150, 152, and 154 respectively based on the need of retailers supplied by the shipments 150, 152, and 154. By determining a need for a store, for example, flow positioning can create efficiencies by replenishing a store's inventory to an appropriate level in less time than by warehousing the items in a traditional manner. For example, flow positioning inventory based on determined need can avoid oversupplying and sending more inventory than a retailer is able to manage appropriately. For example, a store can have limited space to store inventory and if the store is oversupplied beyond an appropriate amount exceeding a storage capacity, storing that oversupplied inventory at the store can become problematic. In some implementations, the inventory replenishment system 128 can track a state of inventory for the supply chain and can determine what retailers are to receive designated products from warehouse inventories in the supply chain. Flow positioning inventory, for example, can be used to maintain appropriate levels of inventory in retail stores in effort to meet demand over time while making efforts to avoid having the product out of stock at the retailer. In some implementations, flow positioning can be used to efficiently distribute products between retailers and manage timing of movement and quantities of inventory to retailers. For example, flow positioning inventory can efficiently send a resupplying shipment to a store in the same day instead of waiting to use traditional methods such as batch processing and warehousing which may happen overnight or longer.

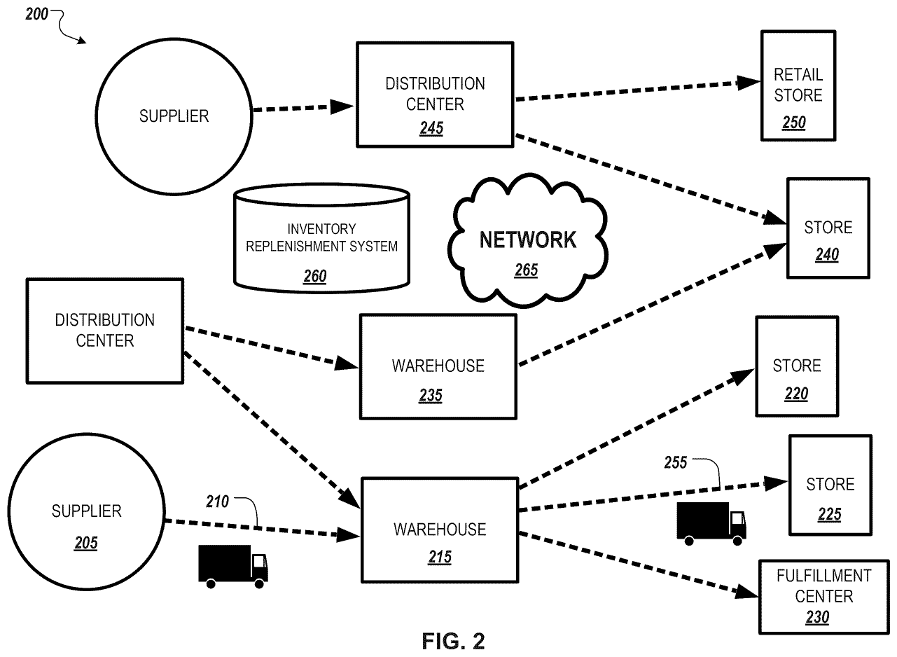

FIG. 2 shows a diagram of an exemplary supply chain that uses flow processing to position inventory. The supply chain 200 includes a network of facilities where inventory can be received and/or sent to move or position retail inventory or merchandise within the supply chain. In the example shown in FIG. 2, one or more suppliers such as supplier 205 can send one or more shipments such as inventory shipment 210 to one or more warehouses such as warehouse 215. For example, a supplier can supply inventory to a warehouse before the inventory is delivered to a retailer. The warehouse 215 can receive the inventory shipment 210 as an inbound shipment from the supplier 205. In some implementations a warehouse can be associated with one or more retail locations such that the warehouse supplies the retail locations with inventory through shipments. For example, warehouse 215 can be associated with and supply retail stores 220 and 225 as well as fulfillment center 230. Also, for example, warehouse 235 can supply retail store 240 and distribution center 245 can supply retail store 240 and retail store 250. In some examples, a warehouse can include a distribution center, a flow center, or the like. In the example of FIG. 2, one or more warehouses such as warehouse 215 can ship inventory 255 to one or more retail stores such as retail store 225 using flow positioning to position inventory in the supply chain 200.

In an exemplary implementation, an inventory replenishment system 260 can track where inventory is located in the supply chain network and can determine where inventory can be moved to within the network of the supply chain 200. In some implementations an inventory replenishment system 260 can be implemented to include an architecture that includes a distributed event store and stream-processing platform (e.g. APACHE KAFKA) distributed over one or more networks such as network 265. In some implementations, the inventory replenishment system 260 can use event streaming to store and process events generated by changes in the supply chain 200 to update and maintain the state of the supply chain 200. In some implementations an inventory replenishment system 260 can be implemented to include one or more containers (e.g., DOCKER containers) running on one or more computing systems. The containers can be distributed over one or more communications networks such as network 265 and/or run in one or more data centers. The inventory replenishment system 260 can track inventory supply movements for various facilities and retailers and can determine where inventory can be moved from to be relocated at designated retailers to replenish retailer inventories. As inventory moves through the supply chain 200 the state of inventory maintained by the inventory replenishment system 260 can be updated to reflect an updated state of inventory. For example, after the inventory shipment 210 arrives at warehouse 215 from supplier 205, the inventory shipment 210 can be evaluated to determine what is in the shipment and the inventory state stored by the inventory replenishment system 260 can be updated to reflect information about the received inventory. For example, the inventory state can be updated with information indicating where an inventory item is located, a quantity of the item, or other information associated with the received items in the shipment. The inventory replenishment system, for example, can store information associated with each item in a shipment (e.g., location identifier, item identifier, shipment identifier, purchase order identifier, etc.). For example, as the state of the supply chain changes, a latest state can be determined by updating the system with one or more recent changes to determine a latest state. In some implementations, intermediate updates can be used to update the state before a latest state is determined. The supply chain state, for example, can include locations, movements, and amounts of items in a supply chain. In some implementations, over time the state of the supply chain can change as inventory can enter the supply chain, move through the supply chain, be altered in the supply chain and/or can exit the supply chain. Tracking inventory, for example, through the supply chain and determining where inventory can be relocated can become more computationally complex and requires more resources as the number of items increases and the number of retailers supplied increases.

Processing the state of the supply chain at a large scale, for example, can be computationally complex and maintaining an accurate state of a supply chain that can change rapidly can be difficult. Updating the state of inventory, for example, before making decisions can create efficiencies as having a more accurate and updated state of inventory can allow for inventory movement decisions to be made more accurately and with less complexity by the inventory replenishment system 260. In some implementations, moving inventory using flow positioning can create efficiencies in computation in a high throughput data environment produced by tracking the state of a supply chain by reducing reliance on longer processes such as batch processing or extended processing times.

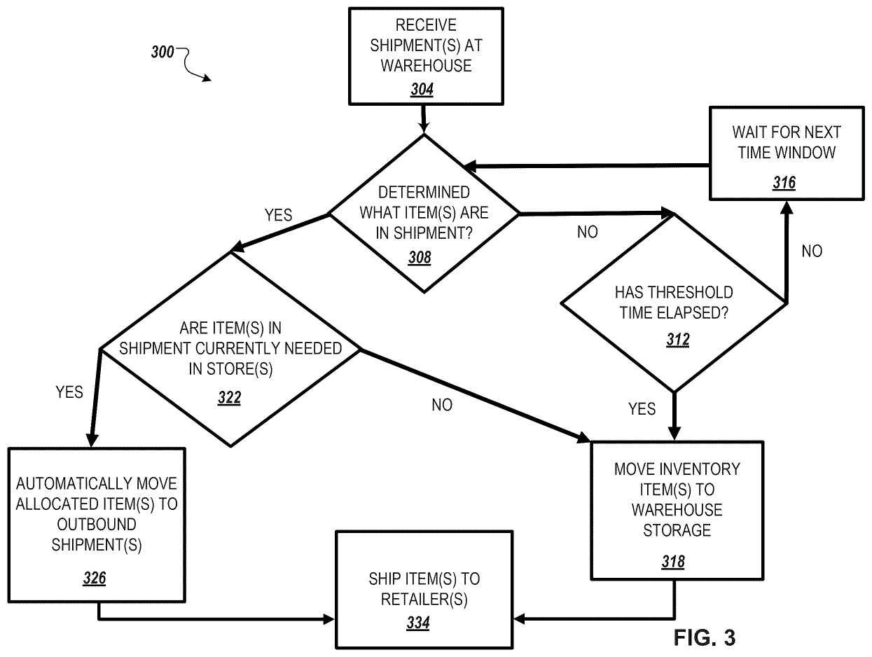

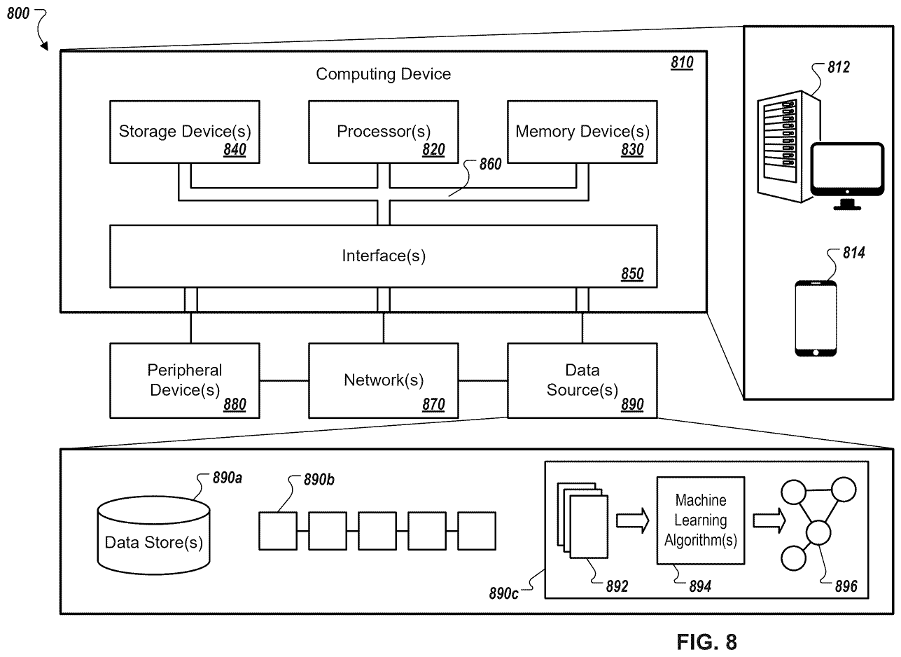

FIG. 3 shows a diagram of an exemplary process 300 for positioning inventory from a warehouse to retailers using flow positioning. The process 300 can be performed using a computing system including an inventory replenishment system, as described and depicted herein. For example, the process 300 can be performed by the computing system 800 in FIG. 8. In step 304, one or more shipments can be received at a warehouse. For example, a transport vehicle such as a truck, trailer, or other vehicle carrying a shipment of inventory arrived at a warehouse can be received. In some implementations, the shipment can include one or more items of one or more inventory products. For example, the shipment can include items of various products that are sold as inventory at retailers supplied by the warehouse. A shipment, for example, can include items or products that can be distributed between one or more different stores within a supply chain network. In some examples, an item in the shipment can be associated with a purchase order identifier such as a number, code or other identifier. In some examples, the item can be associated with the shipment through a shipment identifier such as a number, code or other identifier. In some implementations, when a shipment is received one or more flow signals can be received by an inventory replenishment system to be processed. In some implementations, one or more flow signals can be received for one or more items in a shipment. For example, a different flow signal can be received for each item in a shipment for processing.

At step 308, it is determined if there has been an inventory update determining what one or more items are in the shipment. For example, an inventory replenishment system can make a periodic check to determine if there has been an inventory update for the one or more items in the shipment before a threshold amount of time or if no inventory update has been made prior to the threshold amount of time. In one example, a determination can be made that an inventory replenishment system has been updated with information about what is in a shipment or if there has not been an update to the inventory replenishment system about what is in the shipment. For example, workers can evaluate what inventory items have arrived on a truck and send an inventory update to an inventory replenishment system. In some implementations there can be documentation indicating what items are in the shipment and one or more workers can verify that those items actually arrived with the shipment and update the inventory replenishment system. In some implementations, one or more workers can log what items are in the shipment and what amount of the items arrived in the shipment. For example, using a computer system, a worker can provide log information indicating the items and the amount of the items that are in the shipment to update an inventory replenishment system. In some implementations, a worker can evaluate the items by inspecting, counting, scanning, or other evaluation of the inventory items to provide the information in updating the inventory system. In some implementations, there may be a delay in an evaluation of what inventory is in a shipment and an inventory update may not be made within a threshold amount of time.

If it is determined that there has not been an inventory update regarding what items are in the shipment, at 312, it is determined if a threshold time has elapsed since the shipment was received. For example, a shipment on a truck can be received at a time and a check can be made to determine that an inventory update has not been made for the shipment within one hour of the time or within another threshold amount of time as the threshold amount of time has passed since the receiving time. In some example implementations, a threshold amount of time can be separated into one or more windows of time. For example, a threshold amount of time such as an hour or other predetermined threshold amount of time can be divided into shorter windows of time such as 5 minute windows of time or other windows of time shorter than the threshold amount of time. If it is determined that a threshold amount of time has not elapsed since the shipment was received, then, at 316, the inventory replenishment system can check for an inventory update again after a next window of time within the threshold amount of time. For example, if a shipment is received and an inventory update is not made within a first 5 minute window of time, the inventory replenishment system can wait to process information related to the shipment and can check after a next 5 minute window of time if an inventory update was made for the shipment.

In some implementations, a debouncing process can be used to process updates together in an inventory replenishment system when multiple events occur in a specified time window. In one exemplary implementation updates can be group together if the updates are related (e.g., multiple events for the same item received close in time). In some implementations, an inventory replenishment system can poll within intervals for an update indicating an accounting or inventory of what arrived in a shipment at a warehouse. For example, an inventory replenishment system can determine after a 5 minute window if an inventory update has been made for a shipment associated with a received flow signal and that is awaiting processing. In some implementations, the timely processing of updates can allow for an updated inventory state to be used to make allocation decisions based on more accurate information as time progresses and the state of inventory changes in a supply chain. In some implementations, during a window of time, inventory update information for a shipment can be stored in a database (e.g., a RocksDB or other database) and, after the window of time, the updates can be processed to update the state of the system so that allocation decisions can be made using the updated information. In some implementations, after one time window passes a next time window can be opened and update information can be stored for processing based on the expiration of that next time window. In an exemplary implementation, grouping the number of flow signals to process within windows can assist in avoiding over-allocating products to stores when items for the same product are received on multiple shipments at a warehouse close in time. For example, by processing the flow signals after updates are made to the inventory state in a window, allocation determinations can be made using an updated inventory state. In some implementations, grouping the processing of flow signals for various shipments in interval windows can allow for designated shipments to be prioritized for flow positioning after associated inventory updates are made.

If it is determined that a threshold amount of time has elapsed since the shipment was received, then, at 318, the one or more inventory items in the shipment can be warehoused in warehouse storage. For example, if a shipment is received and one or more items in the shipment have not been evaluated within a threshold amount of time such as one hour or other time then the items in the shipment can be moved from an inbound shipment area (e.g. truck, trailer, vehicle, loading dock, or loading bay) to a storage area within the warehouse where the items can be warehoused before leaving the facility. In some examples the items can be warehoused for extended periods of time (e.g., days, weeks, etc.) before being moved from the warehouse. In some implementations, the items can be warehoused such that they are stored on shelving within the warehouse.

If there has been a determination that an inventory update has been made for the shipment within a threshold amount of time, then, at 322, a determination is made if the one or more inventory items are needed in one or more retail stores associated with the warehouse. In some implementations a warehouse can be associated with one or more retailers such as a retail store, fulfillment location, fulfillment center or other retailer such that the warehouse supplies the one or more retailers. In an exemplary implementation, an inventory replenishment system can determine that one or more stores have a need based on a desired level of inventory and can determine an inventory need amount. For example, each one of a number of retail stores can have a desired level of items for one or more products. If a current level for an item is less than the desired level for the item, then the store can have a need and an inventory need amount can be determined based on the current inventory level of the item and the desired inventory level. In some implementations, the inventory need amount can be set such that a store's inventory for an item can be replenished up to the desired level of inventory. In some implementations, if a store has a need for an inventory item, a flow transfer order request can be generated for an allocation of one or more of the inventory items indicating the allocation of inventory items are to be shipped from the warehouse to the retail location designated by the flow transfer order request. In some implementations, a need can be determined based on a business priority distribution. For example, if more than one retailer has a need for one or more items that can be provided through flow positioning, the retailer with the highest business priority can be allocated the one or more items. In some implementations, a need for a retailer can be based on an order to level metric which can indicate an appropriate (e.g., desired) inventory position of an item at a retail location (e.g. store, fulfillment center, or other retailer) for a designated period of time to support sales and maintain in-stock levels. For example, an order to level metric can indicate how many items of a particular product would be appropriate at a designated location over a time period (e.g., 1 day, 2 days, 8 days, or other amount of time). In some implementations, an inventory replenishment system can determine an allocation amount of items for a product based on the difference between the amount of items for the product located at a retail location and the amount of the items indicated by the order to level metric. For example, an allocation amount can be set to replenish a portion or all of the inventory needed for a retail location. In some implementations, inventory need amounts can be determined using criteria other than an order to level metric to determine how much of an inventory item a store needs. In some implementations, an inventory replenishment system can prioritize high volume stores for inventory replenishment using flow positioning in shorter timeframes based on inventory updates and other stores can be supplied in longer timeframes such as by using warehousing and/or nightly batch processing. Retail stores, for example, can be ranked based on need and an inventory replenishment system can determine allocation amounts for the stores based on the ranking. In an exemplary implementation, an inventory replenishment system can determine allocation amounts for stores can be supplied by designated warehouses associated with the stores. In some implementations, an inventory replenishment system can avoid over allocation based on capacity or space in a store. For example, an inventory replenishment system can stop items from being flow positioned to a store based on a store not having enough capacity or storage to receive the items.

In some implementations, if there has been a determination that an inventory update has been made for the shipment within a threshold amount of time a determination can be made if one or more items in the shipment are designated within a shipment category such as a category of product that is to be shipped from the warehouse before a deadline or other shipment category. For example, products can be categorized or flagged as flammable, as hard allocations, as fixed assortments or other flagged category that indicates how the items or products are to be shipped from the warehouse. In some implementations, the flagged products can be shipped from the warehouse before a deadline such as before the end of a day, end of a shift, or other designated deadline. In some implementations, a computer system, can check if an item or product is associated with a shipment category in a record for the item or product. If it is determined that one or more items in the shipment are within a shipment category, then, at 326, the one or more inventory items can be automatically moved to an outbound shipment area (e.g. loading dock, loading bay, truck, or trailer) to be shipped in an outbound shipment from the warehouse to one or more retailers. In some implementations, a computer system can determine what outbound shipment the items or products will be in based on what retail location has a need for the item or product or what retail location can store the item or product. For example, by a deadline, a flammable item can be included in a shipment from the warehouse to a retail store that has low inventory of the flammable product item. In other implementations, for shipment categorized products, a manual determination can be made to determine what outbound shipment the items or products can be shipped in.

At 326, the one or more inventory items that are determined to be needed at one or more retail stores can be automatically moved from an inbound shipping area to an outbound shipment area (e.g. loading dock, loading bay, truck, or trailer) to be shipped in an outbound shipment from the warehouse. In some implementations an inventory replenishment system can determine what outbound shipment the items or products are to be shipped in based on what retail location has a need for the item or product or what retail location can store the item or product. For example, based on inventory allocations, one or more items can be automatically moved by one or more conveyors to a first outbound dock designated for a shipment to a designated retailer, and different items can be moved by one or more conveyors to one or more different docks to be shipped to one or more different retailers. In some implementations, an inventory replenishment system can indicate that an item be allocated using flow positioning. For example, a flow transfer order request can be created and received to indicate that the items are to be shipped using flow positioning. At step 334, the one or more items allocated in outbound shipments are shipped to one or more retailers. For example, a truck carrying a shipment can move the inventory items or products to one or more stores designated for the shipment to replenish the inventory at the stores.

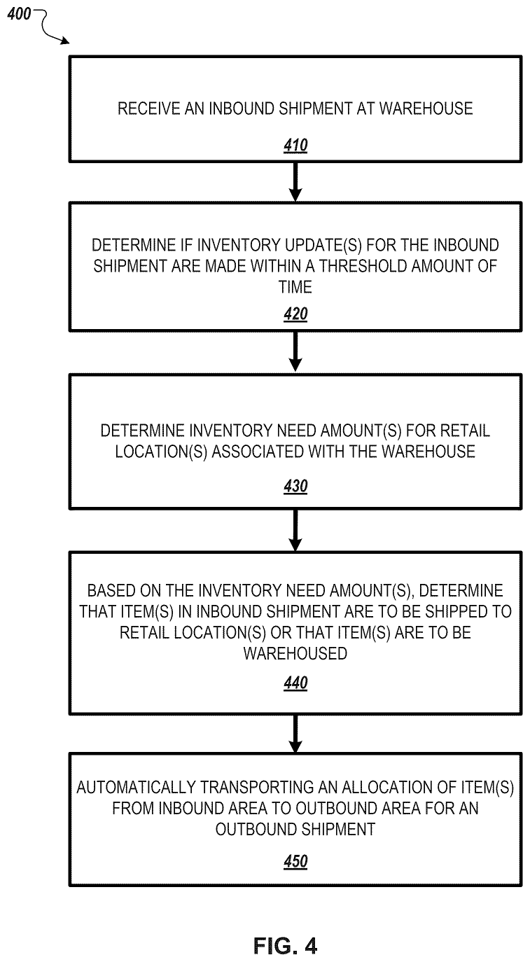

FIG. 4 shows a diagram for a process 400 for positioning inventory in a supply chain using flow positioning. At step 410, one or more inbound shipments are received at one or more warehouses. For example, a truck can arrive with a shipment of inventory at a warehouse and workers can validate that the shipment arrived. In some implementations, the receiving of the shipment includes generating, by a computing system, a flow signal associated with the shipment that can be received by computer system such as an inventory replenishment system. In some implementations, a trailer unload signal can be generated and sent to an inventory replenishment system that is associated with the shipment to be unloaded at the warehouse. In one exemplary implementation, each item of inventory of the shipment can be associated with one or more data including but not limited to an item identification number (e.g., TCIN, or other identification number), location identification number (e.g., location ID), a purchase order identification number, and/or a shipment item identification number. These associated data can be used to associate one or more inventory updates with one or more flow signals and/or other supply chain state data. In some implementations, a location identification number can identify a warehouse location where a shipment arrives.

At step 420, a determination is made, by an inventory replenishment system, if one or more inventory updates for the inbound shipment is made within a threshold amount of time. In an exemplary implementation, when the shipment is received workers can verify paperwork for the shipment and log what is received in the shipment. For example, workers can verify what items were received in the shipment and one or more inventory updates can be sent to an inventory replenishment system indicting what was received in the shipment at the warehouse. In some implementations, an update associated with the shipment can be delayed beyond a threshold amount of time and a determination is made that the items associated with the update can be warehoused instead of rapidly shipped using flow positioning. For example, if one or more flow transfer order requests for items in the shipment are not received from an inventory replenishment system within one hour of receiving the shipment at the warehouse, then workers can move the shipment items to warehouse storage and shelving. In another example, if one or more flow transfer order requests for one or more items in the shipment are not received from an inventory replenishment system before the time the one or more items are to be relocated within the warehouse by workers working the received shipment, then after that time the workers can move those one or more items to warehouse storage and shelving. In some implementations, it can be determined that the inventory update is made within a threshold amount of time (e.g., one hour or other time). For example, an inventory replenishment system can check and determine that an inventory update associated with the received shipment was made within the threshold amount of time. In some implementations, an inventory replenishment system can use windows of time to process inventory update information for determining flow positioning decisions for shipments received at warehouses. For example, an inventory replenishment system can check, using interval windows of time (e.g., 5 minute time windows or other windows of time) within the threshold amount of time, if an inventory update was made within a given window of time. If the inventory update was not made within a first window of time then the inventory replenishment system waits for the next window of time to check again for an inventory update. The inventory replenishment system, for example, can continue to check for the inventory update until the threshold amount of time has elapsed. If an update is determined to be made within a window of time, then associated information can be processed for the shipment. For example, a flow signal and inventory update information associated with the shipment can be processed to determine if items from the shipment are to be shipped through flow positioning or warehoused.

At step 430, one or more inventory need amounts are determined for one or more retail locations associated with the warehouse. For example, an inventory replenishment system can determine if stores that are supplied by the warehouse have a need for the products that arrived in a warehouse shipment and an inventory need amount can be determined for each store indicating how much product inventory is needed by respective stores. In some implementations, the inventory need amount for a store can be determined based on a desired or appropriate level of inventory determined for the store and a current inventory of the store. For example, the inventory need amount can be the amount of inventory needed to replenish a store's inventory up to a desired level. In some implementations, the inventory need amount can be determined for a specified time period. For example, a store can have a need amount set such that the need is determined for a period of 8 days or other time period.

At step 440, based on the one or more inventory need amounts, it is determined if one or more items in the inbound shipment are to be shipped to one or more retailers or if the one or more items are to be warehoused. In some implementations, if it was determined that an update for one or more shipment items was received within a threshold amount of time and that there is a determined need amount for the item at one or more stores then a determination can be made that the one or more items in the inbound shipment are to be shipped through flow positioning. For example, if an inventory update was made within an hour of being received at the warehouse in a shipment and there is an identified need at a store for the item, the inventory replenishment system can provide a flow transfer order request (e.g., transfer order, transfer order request, etc.) indicating an allocation of the one or more items can be shipped to the designated store with the need. A received flow transfer order request, for example, can indicate that the allocation of the one or more items can be flow positioned such that the one or more items can be automatically relocated through the warehouse to be shipped to the designated store with the need instead of warehousing the one or more items in warehouse storage or shelving. In some implementations, if it is determined that an inventory update for the one or more items was not made within a threshold amount of time after being received at the warehouse, a determination can be made that the one or more items can be warehoused and moved into warehouse storage and shelving. In some implementations, if an inventory update is made for a shipment within a threshold amount of time, some items in the shipment can be designated to be shipped using flow positioning based on identified needs of retailers and some items in the shipment can be determined to be warehoused. In some implementations, if an item is determined to be within a shipment category, the item can be determined to be shipped using flow positioning and moved through the warehouse automatically to be shipped to a designated retailer. For example, if an item is categorized as being flammable, it can be determined to be shipped using flow positioning instead of being warehoused.

At step 450, an allocation of one or more items are automatically transported from an inbound area to an outbound area for an outbound shipment. For example, one or more items in the shipment that are determined to be shipped to one or more retailers can be relocated through the warehouse using a conveyor system to an outbound dock for shipping to a designated retailer. For example, an allocation of items indicated by a flow transfer order request can be automatically sorted and moved by a conveyor system from an inbound dock to a designated outbound dock to be shipped to a retailer designated by the flow transfer order request. In some implementations, the allocation of one or more items can be automatically transported for shipping instead of warehousing the allocation. This rapid automated processing and shipping of inventory through flow positioning can be beneficial in that it avoids costs related to warehousing the inventory and can quickly replenish store inventories to appropriate levels.

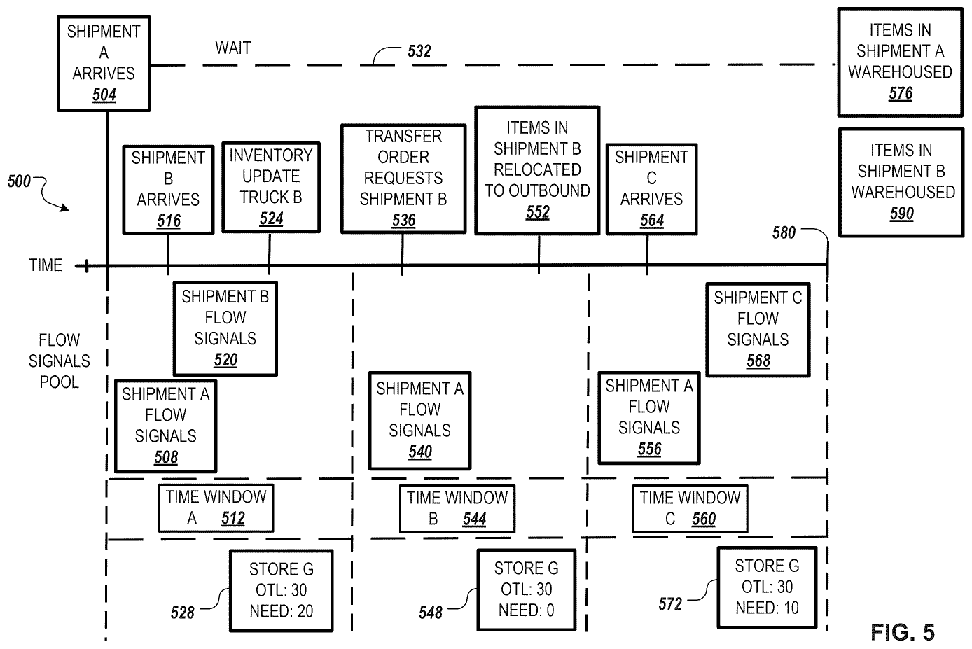

FIG. 5 is a diagram that shows an exemplary implementation of a timeline 500 for the positioning of inventory using flow positioning. In the example of FIG. 5, a first shipment arrives at a warehouse at time shown at 504. After the arrival of the first shipment, one or more flow signals for the first shipment are entered into the flow signals pool waiting to be processed as shown at 508. The one or more flow signals for the first shipment are placed in the flow signals pool during a first time window 512. A second shipment arrives at the warehouse at time shown at 516 and after the arrival, one or more flow signals for the second shipment are entered into the flow signals pool waiting to be processed as shown at 520 in the first time window 512. Inventory updates are made for one or more items in the second shipment at the time shown at 524 which is within the first time window 512. As shown at 528, a first store that is supplied by the warehouse is determined to need 20 items of a product to meet a desired inventory level of 30 items within the first time window 512. As shown at 532, the first shipment waits to be unloaded as there has not been an inventory update for one or more items within the first time window 512.

After the first time window 512 expires, as shown at 540, the one or more flow signals for the first shipment are entered into a flow signals pool for a second time window 544. At the time shown at 536, one or more flow transfer order requests are determined and provided for one or more items in the second shipment after the first time window 512 expires and the flow signals for the second shipment are processed. Based on the one or more flow transfer order requests for the items in the second shipment, as shown at 552, one or more items with associated flow transfer order requests are automatically relocated through the warehouse to one or more outbound shipments determined by the associated flow transfer order requests. As shown at 548, the first store was allocated needed items through flow positioning items from the second shipment and has no need for more of that product during the second time window. In some implementations, if there is a designated need for a product at one or more stores that arrives on more than one shipment and inventory updates and/or flow signals for that product are received within the same time window for their respective shipments, then the flow signal for one of the shipments can be processed and the other product on the other shipments can be warehoused to avoid overallocation. For example, the earliest received flow signal for the product on the earliest received shipment can be chosen to be processed after an inventory update is received within a time window and later received flow signals for the product on later received shipments cannot be processed so that the products on the later shipments are warehoused. This can allow for the allocation of the product from the earliest shipment to meet the identified need of a store without over allocating product to the store through flow processing for later arrived shipments.

After the second time window expires, the first shipment waits to be unloaded as there has not been an inventory update for one or more items within the second time window 544, and, as shown at 556, the one or more flow signals for the first shipment are moved into a flow signal pool waiting to be processed within the third time window 560. At the time shown at 564, a third shipment arrives at the warehouse. After the arrival, as shown at 568, one or more flow signals for one or more items in the third shipment are entered into the flow signals pool within the third time window 560. As shown at 572, during the third time window 560, the first store is showing a need for 10 items of a product with a desired inventory level of 30 items of the product. At the time shown at 580, the threshold time from the arrival of the first shipment expires. After the threshold time expires for the first shipment, the items in the first shipment are moved into warehouse storage, as shown at 576, because there was no inventory updates for the items in the first shipment and the one or more flow signals for the items in the first shipment were not processed. At 590, after the threshold time expires from the arrival of the second shipment, one or more items that were not automatically relocated based on an associated flow transfer order request are moved into warehouse storage for warehousing.

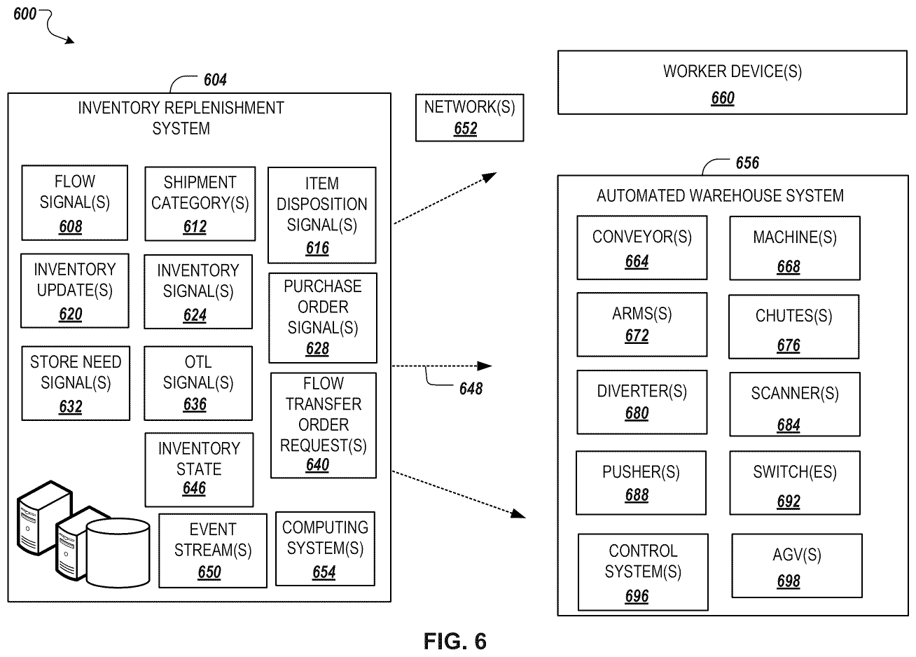

FIG. 6 is a diagram that shows exemplary systems 600 used in the positioning of inventory using flow positioning. In the exemplary implementation of FIG. 6, an inventory replenishment system 604 can receive and/or send one or more signals that include one or more flow signals 608, one or more shipment category signals 612 one or more item disposition signals 616, one or more inventory update signals 620, one or more inventory signal 624, one or more purchase order signals 628, one or more store need signals 632, and/or one or more order to level signals 636. The inventory replenishment system 604 can also store and provide the state of inventory of a supply chain as shown at 646. The inventory replenishment system 604 can also include one or more event streams 650 and/or one or more computing systems 654. The exemplary inventory replenishment system 604 can receive and/or send one or more flow transfer order requests 640. For example, a flow transfer order request can be emitted to the automated warehouse system 656 with included allocation instructions. The exemplary inventory replenishment system can send one or more signals 648 to one or more systems that include one or more worker devices 660 or automated warehouse system 656. The exemplary inventory replenishment system can send and/or receive one or more communications using one or more networks 652. In some exemplary implementations, the automated warehouse system 656 can use one or more systems individually or in combination to physically move inventory through a warehouse that include the systems of one or more conveyors 664, one or more machines 668, one or more automated arms 672, one or more chutes 676, one or more diverters 680, one or more scanners 684, one or more pushers 688, one or more switches 692, one or more control systems 696, or one or more automated guided vehicles 698. In one exemplary implementation, the one or more control systems 696 can be used to automatically control one or more systems of the automated warehouse system 656 either individually or in combination to physically move inventory through a warehouse.

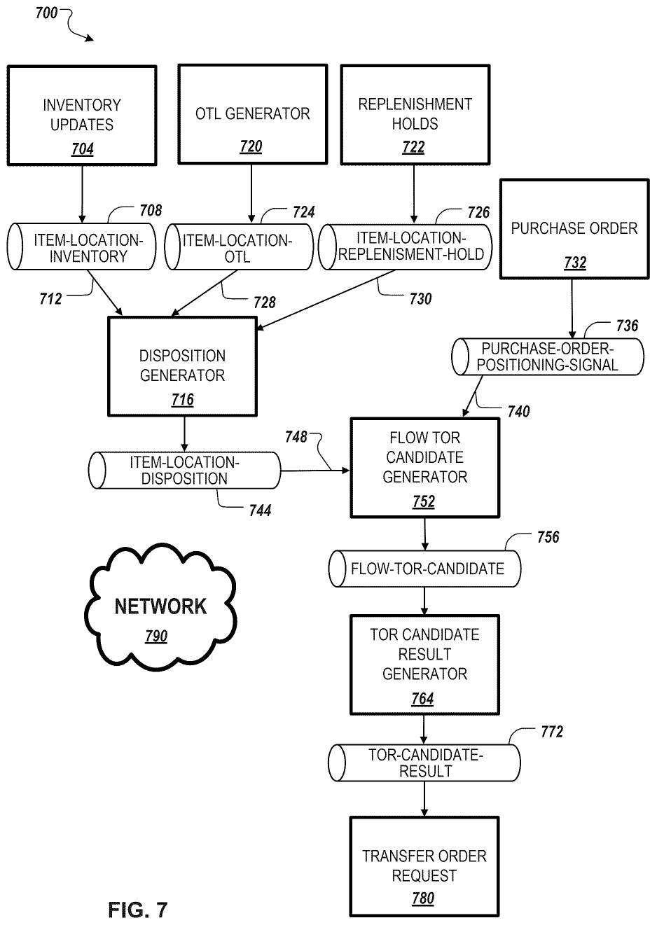

FIG. 7 shows a diagram of an exemplary architecture 700 used for positioning of inventory through flow positioning. In some implementations, the exemplary architecture 700 can be included in an implementation of an inventory replenishment system such as inventory replenishment system 260. An implementation of the architecture 700 can include the use of one or more computing systems as described and depicted herein. For example, the architecture 700 can be implemented including the use of the computing system 800 in FIG. 8. In some implementations, the architecture 700 can include a distributed event store and stream-processing platform (e.g. APACHE KAFKA, etc.) distributed over one or more networks such as network 790 and/or one or more databases (e.g. RocksDb, etc.). In some implementations, the architecture 700 can include the use of event streaming to store and process events generated by changes in a supply chain to update and maintain the state of the supply chain. The architecture 700 can include one or more topics distributed over one or more clusters. For example, one or more events used in event streaming can be stored in and/or received from one or more topics as signals. In some examples, the one or more topics can be partitioned into one or more partitions. In the example of FIG. 7, one or more inventory updates can be processed at 704, and that information can be stored and accessible through topic signals as shown at 708. At 720 the desired inventory levels for items in the supply chain can be determined at their respective locations and that information for each item at the item identification level can be stored and accessible through topic signals as shown at 724. At 722 one or more replenishment holds for inventory items in the supply chain can be determined for preventing movement of the inventory items from warehouse locations and that information can be stored and accessible through topic signals as shown at 726. At 712, inventory information for items at their locations can be accessible to a disposition generator 716. At 728, information about desired levels of inventory for items at their locations can be accessible to a disposition generator 716. At 730, information about replenishment holds such as override instructions for preventing movement of items from a warehouse can be accessible to a disposition generator 716. The disposition generator 716 can determine disposition information for items in the supply chain at their respective locations and that information can be stored and accessible through topic signals as shown at 744. Purchase order information can be generated at 732 and can be stored and accessible through topic signals as shown at 736. Information for determining flow signals for items in a supply chain can be generated at the flow transfer order candidate generator 752 and information for flow signals for items can be stored and accessible through topic signals as shown at 756. The flow transfer order candidate generator 752 can access disposition information for items at their locations as shown at 748 and can access purchase order information for items in the supply chain as shown at 740. In the exemplary implementation of FIG. 7, flow transfer order request information can be generated at a flow transfer order request candidate result generator 764 and information for flow transfer order requests for items in the supply chain can be stored and accessible through topic signals as shown at 772. Also, one or more generated transfer order requests 780 can be stored and accessible for one or more items in the supply chain.

FIG. 8 is a schematic diagram that shows an example of a computing system 800 that can be used to implement the techniques described herein. The computing system 800 includes one or more computing devices (e.g., computing device 510), which can be in wired and/or wireless communication with various peripheral device(s) 880, data source(s) 890, and/or other computing devices (e.g., over network(s) 870). The computing device 810 can represent various forms of stationary computers 812 (e.g., workstations, kiosks, servers, mainframes, edge computing devices, quantum computers, etc.) and mobile computers 814 (e.g., laptops, tablets, mobile phones, personal digital assistants, wearable devices, etc.). In some implementations, the computing device 810 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 810, and an entire system can be made up of multiple devices communicating with each other. For example, the computing device 810 can be part of a computing system that includes a network of computing devices, such as a cloud-based computing system, a computing system in an internal network, or a computing system in another sort of shared network. Processors of the computing device (810) and other computing devices of a computing system can be optimized for different types of operations, secure computing tasks, etc. The components shown herein, and their functions, are meant to be examples, and are not meant to limit implementations of the technology described and/or claimed in this document.

The computing device 810 includes processor(s) 820, memory device(s) 830, storage device(s) 840, and interface(s) 850. Each of the processor(s) 820, the memory device(s) 830, the storage device(s) 840, and the interface(s) 850 are interconnected using a system bus 860. The processor(s) 820 are capable of processing instructions for execution within the computing device 810, and can include one or more single-threaded and/or multi-threaded processors. The processor(s) 820 are capable of processing instructions stored in the memory device(s) 830 and/or on the storage device(s) 840. The memory device(s) 830 can store data within the computing device 810, and can include one or more computer-readable media, volatile memory units, and/or non-volatile memory units. The storage device(s) 840 can provide mass storage for the computing device 810, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 850 can include various communications interfaces (e.g., USB, Near-Field Communication (NFC), Bluetooth, WiFi, Ethernet, wireless Ethernet, etc.) that can be coupled to the network(s) 870, peripheral device(s) 880, and/or data source(s) 890 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 850 can include a control interface that receives commands from an input device (e.g., operated by a user) and converts the commands for submission to the processors 820. The interface(s) 850 can include a display interface that includes circuitry for driving a display to present visual information to a user. The interface(s) 850 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 870 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 810 can communicate with the peripheral device(s) 880, the data source(s) 890, and/or other computing devices over the network(s) 870. In some implementations, the computing device 810 can directly communicate with the peripheral device(s) 880, the data source(s), and/or other computing devices.

The peripheral device(s) 880 can provide input/output operations for the computing device 810. Input devices (e.g., keyboards, pointing devices, touchscreens, microphones, cameras, scanners, sensors, etc.) can provide input to the computing device 810 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 810 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 890 can provide data for use by the computing device 810, and/or can maintain data that has been generated by the computing device 810 and/or other devices (e.g., data collected from sensor devices, data aggregated from various different data repositories, etc.). In some implementations, one or more data sources can be hosted by the computing device 810 (e.g., using the storage device(s) 840). In some implementations, one or more data sources can be hosted by a different computing device. Data can be provided by the data source(s) 890 in response to a request for data from the computing device 810 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 890a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 890b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 890c. The machine learning system(s) 890c, for example, can be used to analyze data from various sources (e.g., data provided by the computing device 810, data from the data store(s) 890a, data from the blockchain(s) 890b, and/or data from other data sources), to identify patterns in the data, and to draw inferences from the data patterns. In general, training data 892 can be provided to one or more machine learning algorithms 894, and the machine learning algorithm(s) can generate a machine learning model 896. Execution of the machine learning algorithm(s) can be performed by the computing device 810, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents supply chain information. The machine learning model that results from the machine learning algorithm(s) can be used to position inventory using flow positioning. Use of the machine learning model can provide the benefit of efficiently positioning inventory in a supply chain.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer system for positioning inventory, the computer system comprising:
one or more processors; and
computer-readable memory storing instructions that, when executed by the processors, cause the processors to perform operations comprising:
receiving an inbound shipment at a warehouse;
determining, by an inventory replenishment system, if one or more inventory updates for the inbound shipment are made within a threshold amount of time;
determining one or more inventory need amounts for one or more retail locations associated with the warehouse;
based on the one or more inventory need amounts, determining, by the inventory replenishment system, that one or more items in the inbound shipment are to be shipped or that the one or more items are to be warehoused; and
automatically transporting an allocation of the one or more items from an inbound area to an outbound area for an outbound shipment.

2. The computer system of claim 1, wherein the determining if the one or more inventory updates have been made within the threshold amount of time comprises determining that the one or more inventory updates were not made within a first window of time; and
wherein the determining if the one or more inventory updates have been made within the threshold amount of time further comprises determining that the one or more inventory update have been made within a second window of time, wherein the first window of time and the second window of time are within the threshold amount of time.

3. The computer system of claim 2, wherein the operations further comprise:
waiting to process one or more flow signals associated with the shipment based on the determining that the one or more inventory updates were not made within the first window of time; and
processing the one or more flow signals associated with the shipment based on determining that the one or more inventory updates have been made within the second window of time.

4. The computer system of claim 1, wherein the automatically transporting the allocation of the one or more items comprises transporting the one or more items using one or more conveyor systems.

5. The computer system of claim 1, wherein the determining, by the inventory replenishment system, that one or more items in the inbound shipment are to be shipped or that the one or more items are to be warehoused comprises determining that a flow transfer order request has been received for the one or more items.

6. The computer system of claim 1, wherein the operations further comprise:
determining the allocation of one or more items based on the one or more inventory need amounts, wherein the one or more inventory need amounts are determined for a time period.

7. The computer system of claim 1, wherein determining, by the inventory replenishment system, that the one or more items in the inbound shipment are to be shipped or that the one or more items are to be warehoused comprises determining that the one or more items are associated with a shipment category.

8. The computer system of claim 1, wherein the receiving the inbound shipment at the warehouse comprises receiving a flow signal associated with the inbound shipment; wherein the determining, by the inventory replenishment system, that the one or more items in the inbound shipment are to be shipped or that the one or more items are to be warehoused comprises generating a flow transfer order request for the one or more items; and
based on the flow transfer order request, shipping the one or more items in the outbound shipment to the one or more retail locations.

9. The computer system of claim 1, wherein the automatically transporting the allocation of the one or more items from an inbound area to an outbound area for an outbound shipment comprises transporting the allocation of the one or more items within the same day without warehousing the allocation of the one or more items.

10. The computer system of claim 1, wherein the automatically transporting the allocation of the one or more items from the inbound area to an outbound area for the outbound shipment comprises identifying the one or more items by scanning the one or more items while the one or more items are guided through a conveyor system.

11. A method for positioning inventory, the method comprising:
receiving an inbound shipment at a warehouse;
determining, by an inventory replenishment system, if one or more inventory updates for the inbound shipment are made within a threshold amount of time;
determining one or more inventory need amounts for one or more retail locations associated with the warehouse;
based on the one or more inventory need amounts, determining, by the inventory replenishment system, that one or more items in the inbound shipment are to be shipped or that the one or more items are to be warehoused; and
automatically transporting an allocation of the one or more items from an inbound area to an outbound area for an outbound shipment.

12. The method of claim 11, wherein the determining if the one or more inventory updates have been made within the threshold amount of time comprises determining that the one or more inventory updates were not made within a first window of time;
and
wherein the determining if the one or more inventory updates have been made within the threshold amount of time further comprises determining that the one or more inventory updates have been made within a second window of time, wherein the first window of time and the second window of time are within the threshold amount of time.

13. The method of claim 12, wherein the method further comprises:
waiting to process one or more flow signals associated with the shipment based on the determining that the one or more inventory updates were not made within the first window of time; and
processing the one or more flow signals associated with the shipment based on determining that the one or more inventory updates have been made within the second window of time.

14. The method of claim 11, wherein the automatically transporting the allocation of the one or more items comprises transporting the one or more items using one or more conveyor systems.

15. The method of claim 11, wherein the determining, by the inventory replenishment system, that one or more items in the inbound shipment are to be shipped or that the one or more items are to be warehoused comprises determining that a flow transfer order request has been created for the one or more items.

16. The method of claim 11, wherein the method further comprises:
determining the allocation of one or more items based on the one or more inventory need amounts, wherein the one or more inventory need amounts are determined for a time period.

17. The method of claim 11, wherein determining, by the inventory replenishment system, that the one or more items in the inbound shipment are to be shipped or that the one or more items are to be warehoused comprises determining that the one or more items are associated with a shipment category.

18. The method of claim 11, wherein the receiving the inbound shipment at the warehouse comprises receiving a flow signal associated with the inbound shipment; wherein the determining, by the inventory replenishment system, that the one or more items in the inbound shipment are to be shipped or that the one or more items are to be warehoused comprises generating a flow transfer order request for the one or more items; and
based on the flow transfer order request, shipping the one or more items in the outbound shipment to the one or more retail locations.

19. The method of claim 11, wherein the automatically transporting the allocation of the one or more items from an inbound area to an outbound area for an outbound shipment comprises transporting the allocation of the one or more items within the same day without warehousing the allocation of the one or more items.

20. The method of claim 11, wherein the automatically transporting the allocation of the one or more items from the inbound area to an outbound area for the outbound shipment comprises identifying the one or more items by scanning the one or more items while the one or more items are guided through a conveyor system.
